(19) United States
(12) Patent Application Publication
(10) Pub. No.: US 2023/0058137 A1
(43) Pub. Date: Feb. 23, 2023

(54) INJECTION MOLDING SOLE MATERIAL, SOLE CONTAINING SAME AND PREPARATION METHOD AND APPLICATION THEREOF

(71) Applicant: MYUNG GON KIM, Busan Metropolitan City (KR)

(72) Inventor: MYUNG GON KIM, Busan Metropolitan City (KR)

(21) Appl. No.: 17/399,666

(22) Filed: Aug. 11, 2021

(51) Int. Cl. A43B 13/04; A43B 13/12; C08L 67/02; C08L 91/00; C08L 9/06; C08L 53/02; C08K 3/08; C08K 3/22

(52) U.S. Cl. CPC A43B 13/04; A43B 13/12; C08L 67/02; C08L 91/00; C08L 9/06; C08L 53/02; C08K 3/08; C08K 3/22; C08K 2003/2296

(57) ABSTRACT

The present invention belongs to the technical field of injection molding soles, and particularly relates to an injection molding sole material, sole containing same and preparation method and application thereof. The invention can solve the environmental pollution caused by the extensive use of petroleum-based polymer compounds in the existing shoe sole materials, by subjecting the PLA to chain extension modification, the modified PLA has better toughness and compatibility, the injection molding sole material prepared from the modified PLA and other raw materials has thermal stability, oxidation resistance, heat resistance and compressive strength, the application field of the PLA is greatly expanded, the PLA material is introduced into the shoemaking industry for the first time, which guides and promotes the development of degradable shoe material.

### TECHNICAL FIELD

The present invention belongs to the technical field of injection molding soles, and particularly relates to an injection molding sole material, sole containing same and preparation method and application thereof.

### BACKGROUND ART

Common sole materials mainly comprise ethylene vinyl acetate (EVA), thermoplastic polyurethane (TPU), cast polyurethane (PU), other thermoplastic elastomers such as polyolefin elastomer (POE), olefin block copolymer (OBC), styrene-butadiene-styrene block copolymer (SBS), ethylene propylene diene monomer rubber (EPDM), ethylene octene block copolymer (OBC), styrene block copolymer (SEBS), polyethylene (PE), cis-polybutadiene rubber (BR), styrene butadiene rubber (SBR), nitrile butadiene rubber (NBR), chloroprene rubber (CR), isoprene rubber (IR) and the like. However, the above materials are mainly derived from petroleum-based materials, and the mass consumption and rapid development of the shoe industry not only consume a large number of limited petrochemical resources, but also because they cannot be degraded in nature in a short period of time, as the waste shoes are discarded, they have become, an environment heavy burden, the “white trash”. Incineration is commonly used for treatment and disposal, but it causes secondary pollution of atmospheric environment and poses a great threat to human and ecological environment. Therefore, the development of biodegradable shoe materials has become an inevitable trend.

Polylactic acid (PLA) is a kind of biomass polymer that can be regenerated, which is obtained by fermentation of natural starch to lactic acid, and then by further synthesis of lactic acid to obtain high polymer PLA. PLA can be finally decomposed into CO₂ and H₂O in the environment without causing pollution and damage to the environment, so PLA is considered to be an environment-friendly fully degradable high-molecular material. However, due to poor thermal stability, poor heat resistance, high cost, poor toughness, brittleness, high hardness and low molecular weight, pure polylactic acid is generally used for disposable appliances, packaging film bags, labels, packaging containers, household appliances and other electronic products, and further popularization and application thereof are limited.

### SUMMARY OF THE INVENTION

In view of the above-mentioned technical problems existing in the background art, there is a need to provide an injection molding sole material, a sole comprising the same, and a preparation method and application thereof, wherein the injection molding sole material carries out chain extension modification on pure PLA, expands the application field of PLA by utilizing the advantages of biodegradability, good toughness and compatibility of the modified PLA, fills the technical blank of PLA in the aspect of sole application, and improves the environment-friendly property of the sole material.

To achieve the above objects, in a first aspect of the present invention, the inventors provide an injection molding sole material comprising, in parts by weight:

25-40 parts of modified PLA;

5-15 parts of epoxidized soybean oil;

10-20 parts of SBS 875;

15-20 parts of SEBS 503;

10-20 parts of heavy calcium;

20-30 parts of naphthenic oil;

0.1 parts of anti-ultraviolet agent 326;

0.1 parts of heat stabilizer 1010;

0.2 parts of light stabilizer 531;

2-4 parts of tackifying resin;

0.5 parts of microsphere foaming agent; and

2-4 parts of wear-resistant agent NM-406.

CN 109824972A discloses an environment-friendly foamed insole material and a preparation method thereof, wherein EVA and bio-based EPDM are mainly used as main components to produce a biodegradable foamed insole material, but the biodegradable foamed insole material is still based on petrochemical products described in the background, and the production and application processes of the foamed insole material cannot eliminate adverse effects on the environment. The Chinese patent document CN 101864156B discloses a polylactic acid material and a preparation method thereof, wherein the number average molecular weight of the polylactic acid material is 80,000-200,000, the polylactic acid is toughened and modified by adopting a hydroxymethyl acrylamide and acrylate copolymer, and the aim of the invention is to provide a new transparent material of polylactic acid with high toughness and less reduction of strength and rigidity, especially in the fields of transparent film and packaging. The application of petroleum-based high-molecular compound compounds to sole materials and the modification of polylactic acid to improve the application thereof in packaging and transparent films are also reported in the prior art, but it has not been seen that polylactic acid has been modified to be applied to shoe sole materials to solve the problem of environmental pressure caused by the large amount of discarded shoes and other daily consumer products. In the process of discovering the invention, the inventor has long paid attention to the problem of the petroleum-based high polymer material shoe sole and actively searched for a solution path. The biological originality and biodegradability of PLA make PLA an excellent mediator to resolve the contradiction between market demand and environmental problems. |However, the disadvantages of poor thermal stability, poor heat resistance, high cost, poor toughness, brittleness, high hardness and low molecular weight of PLA still need to be overcome.

The epoxidized soybean oil (ESO) used in the present invention is soluble in most organic solvents and hydrocarbons and insoluble in water. It has excellent heat resistance, light resistance and miscibility. It is commonly used as a plasticizer in polyvinyl chloride products, especially in transparent polyvinyl chloride products, food packaging products and other non-toxic products.

SBS 875 adopted is SBS 875 subjected to heating, oil-extending and plasticizing, and SEBS 503 is SEBS 503 subjected to heating, oil-extending and plasticizing.

Tackifying resin, the preferred use of terpene resin, has long lasting viscosity and light white color. By using the microsphere foaming agent, the phenomenon of internal cavities caused by common chemical foaming agents is avoided, and the uniformity is good.

The wear-resistant agent NM-406 is used as a high-molecular wear-resistant agent and has a slow release effect.

Distinguishing from the prior art, the above-mentioned technical solution has at least the following beneficial effects:

in the invention, by subjecting the PLA to chain extension modification, the modified PLA has better toughness and compatibility, the injection molding sole material prepared from the modified PLA and other raw materials has thermal stability, oxidation resistance, heat resistance and compressive strength, the application field of the PLA is greatly expanded, the PLA material is introduced into the shoemaking industry for the first time, which guides and promotes the development of degradable shoe material.

### DETAILED DESCRIPTION OF THE INVENTION

Hereinafter, the injection molding sole material of the first aspect, the preparation method of the injection molding sole material of the second aspect, the sole of the third aspect, and the use of the injection molding sole material of the fourth aspect of the present invention will be described in detail.

The injection molding sole material of the first aspect of the present invention is first described.

An injection molding sole material comprises the following components in parts by weight:

25-40 parts of modified PLA;

5-15 parts of epoxidized soybean oil;

10-20 parts of SBS 875;

15-20 parts of SEBS 503;

10-20 parts of heavy calcium;

20-30 parts of naphthenic oil;

0.1 parts of anti-ultraviolet agent 326;

0.1 parts of heat stabilizer 1010;

0.2 parts of light stabilizer 531;

2-4 parts of tackifying resin;

0.5 parts of microsphere foaming agent;

and 2-4 parts of wear-resistant agent NM-406.

In a preferred embodiment of the present invention, the modified PLA is obtained by modifying PLA, PBAT, SBS-3546 and TMPTA under the action of a crosslinking accelerator.

PBAT belongs to thermoplastic biodegradable plastics, is a copolymer of butylene adipate and butylene terephthalate (aliphatic and aromatic), has the characteristics of PBA and PBT, good ductility and elongation at break, as well as good heat resistance and impact resistance; in addition, the biodegradable plastic has excellent biodegradability, and is one of the most active and market-applied degradable materials in the research of biodegradable plastics.

TMPTA (trimethylolpropane triacrylate) is stable at normal temperature and pressure. It is mainly used in the aspects of photocuring coatings, photocuring inks, photoresists, flexible printed matters, solder resists, resists, paints, polymer modification and the like. It is used in the present invention as a crosslinking agent.

The crosslinking accelerator can also be called as a crosslinking catalyst, is a preparation for catalyzing the development of a crosslinking reaction, improves the crosslinking reaction rate, and is used in a small amount.

The PLA/PBAT chain extension technology adopted by the invention adopts a novel method of a dynamic crosslinking process, wherein the crosslinking agent TMPTA (trimethylolpropane triacrylate) is an efficient crosslinking inducer and a weak crosslinking agent. Under the catalysis of the crosslinking accelerator zinc oxide, partial incomplete crosslinking is generated between PLA and both ends of PLA and between PLA and PBAT, the molecular weight of the modified PLA is enlarged, and the modified PLA has better toughness. The addition of SBS-3546 reduces the melt temperature and hardness of the blend, and enables the next modification reaction to continue, which is the first time adopted in the shoe-making material industry.

As a preferred embodiment of the present invention, the crosslinking accelerator is zinc oxide. Zinc oxide is a non-toxic and commonly used oxide cross-linking agent, and the adopted crosslinking accelerator can also increase the thermal conductivity of the material (shorten the cooling time of the product) in the later period.

As a preferred embodiment of the present invention, in the preparation process of the modified PLA, 15 parts of PBAT, 1-2 parts of TMPTA, 2 parts of zinc oxide and 10 parts of SBS-3546 are added per 100 parts of PLA in parts by weight. The modified PLA prepared by the method has a better molecular weight value range, so that the modified PLA has the best characteristics of application in injection molding sole materials.

Next, a preparation method of the injection molding sole material of the second aspect of the present invention will be described.

A preparation method of an injection molding sole material comprises the following steps of: oil-extending, heating and plasticizing SBS 875 and SEBS 503 to the required hardness to obtain plasticized SBS 875 and plasticized SEBS 503;

putting 25-40 parts of modified PLA, 10-20 parts of plasticized SBS 875, 15-20 parts of plasticized SEBS 503, 10-20 parts of heavy calcium, 0.1 parts of heat stabilizer 1010, 0.2 parts of light stabilizer 531, 20-30 parts of naphthenic oil, 2-4 parts of wear-resistant agent NM-406, 0.1 parts of anti-ultraviolet agent 326 and 2-4 parts of tackifying resin into a stirrer, uniformly mixing, adding 5-15 parts of epoxidized soybean oil, setting the stirring temperature to be 60° C., and continuously mixing until the epoxidized soybean oil is completely absorbed to obtain an injection molding material to be foamed;

extruding the injection molding material to be foamed into particles by using a screw extruder at 180° C., and cooling to obtain the injection molding particles to be foamed;

and adding 0.5 parts of microsphere foaming agent into the injection molding particles to be foamed, and uniformly mixing to obtain the injection molding sole material.

As a preferred embodiment of the present invention, the hardness of the plasticized SBS 875 and plasticized SEBS 503 are 54A and 28A, respectively.

As a preferred embodiment of the present invention, the modified PLA has a molecular weight of 10,000-15,000.

As a preferred embodiment of the present invention, the particle size of the injection molding particles to be foamed is 2.5±0.2 mm in diameter and 2.5±0.2 mm in length.

Next, the sole according to the third aspect of the present invention is described, which comprises the injection molding sole material according to the first aspect of the present invention.

Finally, the use of an injection molding sole material according to the fourth aspect of the invention is described, which is an injection molding sole material according to the first aspect of the invention. The use of the injection molding sole material is not only applied to production and manufacture of soles, but also can be used for production and manufacture of products such as protective sleeves, protective pads and the like of protective appliances with special requirements on toughness, biodegradability and certain elasticity.

In order to explain the technical contents, structural features, achieved objects and effects of the technical solutions in detail, reference is made to the following detailed description taken in conjunction with the specific embodiments and accompanying drawings. It is to be understood that these examples are merely illustrative of the present application and are not intended to limit the scope of the present application.

The reagents adopted in the present invention are as follows:

| | |
|---|---|
| PLA 4032D | American Nature works |
| PBAT | Xinjiang Blue Ridge Tunhe Chemical Industry Joint Stock Co., Ltd |
| TMPTA | Allnex (China) Co., Ltd |
| Zinc Oxide | Shanghai Baishi Chemical Co., Ltd |
| SBS 3546 | Sinopec Maoming Petrochemical Company |
| SBS 875 | Sinopec Maoming Petrochemical Company |
| Naphthenic oil | Xinjiang Karamay Chemical Co., Ltd. |
| Epoxidized soybean oil | Jiangsu Runfeng Synthetic Technology Co., Ltd. |
| SEBS 503 | Sinopec Yueyang Petrochemical Co., Ltd |
| Heavy calcium (1200 mesh) | Jiangxi Guangyuan Chemical Co., Ltd |
| Composite antioxidant PH-06 | Quanzhou Puhui Trade Co., Ltd |
| Wear-resistant agent NM-406 | Quanzhou Puhui Trade Co., Ltd |
| Anti-ultraviolet agent 326 | Li' anlong Supply Chain Management Co., Ltd |
| Heat stabilizer 1010 | Li' anlong Supply Chain Management Co., Ltd |
| light stabilizer 531 | Li' anlong Supply Chain Management Co., Ltd |
| Tackifying resin BT350DX | Shenzhen Jitian Chemical Co., Ltd |
| Microsphere foaming agent | Xineng Chemical Technology (Shanghai) Co., Ltd |

### Example 1 Modified PLA and Preparation Method Thereof

PLA4032D 100 kg, PBAT 15 kg, TMPTA 1 kg, zinc oxide 2 kg and SBS-3546 10 kg are uniformly stirred and mixed in a stirring tank, the outlet of the stirring tank is connected to a single screw extruder, uniformly mixed materials are conveyed to the single screw extruder, the set temperature is 210° C., and the materials are extruded at the rotating speed of 50 rpm to obtain the modified PLA.

### Example 2 Modified PLA and Preparation Method Thereof

PLA4032D 100 kg, PBAT 15 kg, TMPTA 1.5 kg, zinc oxide 2 kg and SBS-3546 10 kg are uniformly stirred and mixed in a stirring tank, the outlet of the stirring tank is connected to a single screw extruder, uniformly mixed materials are conveyed to the single screw extruder, the set temperature is 210° C., and the materials are extruded at the rotating speed of 50 rpm to obtain the modified PLA.

### Example 3 Modified PLA and Preparation Method Thereof

PLA4032D 100 kg, PBAT 15 kg, TMPTA 2 kg, zinc oxide 2 kg and SBS-3546 10 kg are uniformly stirred and mixed in a stirring tank, the outlet of the stirring tank is connected to a single screw extruder, uniformly mixed materials are conveyed to the single screw extruder, the set temperature is 210° C., and the materials are extruded at the rotating speed of 50 rpm to obtain the modified PLA.

### Example 4 Modified PLA and Preparation Method Thereof

PLA4032D 100 kg, PBAT 15 kg, TMPTA 5 kg, zinc oxide 2 kg and SBS-3546 10 kg are uniformly stirred and mixed in a stirring tank, the outlet of the stirring tank is connected to a single screw extruder, uniformly mixed materials are conveyed to the single screw extruder, the set temperature is 210° C., and the materials are extruded at the rotating speed of 50 rpm to obtain the modified PLA.

The performance index test results of the modified PLA obtained in Examples 1-4 are shown in Table 1.

TABLE 1
Modified PLA performance index provided by Examples 1-4

| | | Example 1 | Example 2 | Example 3 | Example 4 |
|---|---|---|---|---|---|
| | Original | Modified | Modified | Modified | Modified |
| Item | sample | PLA | PLA | PLA | PLA |
| Hardness | 88 | 70 | 70 | 70 | 70 |
| (A) | | | | | |
| Specific | 1.25 ± 0.05 | 28 | 30 | 32 | 28 |
| gravity | | | | | |
| (g/cm³) | | | | | |
| Tensile | 35 | 1.20 | 1.20 | 1.20 | 1.20 |
| strength | | | | | |
| (MPa) | | | | | |
| Elongation | 3.5 | 25 | 45 | 70 | 30 |
| (%) | | | | | |
| Melt index | 16 | 18 | 18 | 16 | 20 |
| (210° C., | | | | | |
| 5 kg) | | | | | |
| Melting | 165 | 140 | 140 | 140 | 140 |
| point ° C. | | | | | |

It can be seen from Table 1 that for the toughening manner by cross-linking chain extension, the addition of the cross-linking agent TMPTA of 2 parts is preferable, the modified chain extension effect is not significant due to insufficient chain extension efficiency when less than 2 parts, but when the amount of the cross-linking agent is increased to 5 parts, embrittlement and elongation of the modified PLA are reduced due to partial over-crosslinking.

Due to the mixing of SBS, the melting point of the mixture drops to 140° C. and there are many options for subsequent processing using a screw mill.

### Example 5 Injection Molding Sole Material and Preparation Method Thereof

heating, oil-extending and plasticizing SBS 875 and SEBS 503 to the required hardness to obtain plasticized SBS 875 and plasticized SEBS 503;

putting 25 parts of modified PLA obtained from Examples 1-4, 20 parts of plasticized SBS 875, 20 parts of plasticized SEBS 503, 20 parts of heavy calcium, 0.1 parts of heat stabilizer 1010, 0.2 parts of light stabilizer 531, 20 parts of naphthenic oil, 2 parts of wear-resistant agent NM-406, 0.1 parts of anti-ultraviolet agent 326 and 2 parts of tackifying resin into a stirrer, uniformly mixing, adding 5 parts of epoxidized soybean oil, setting the stirring temperature to be 60° C., and continuously mixing until the epoxidized soybean oil is completely absorbed to obtain an injection molding material to be foamed;

extruding the injection molding material to be foamed into particles by using a screw extruder at 180° C., and cooling to obtain the injection molding particles to be foamed;

and adding 0.5 parts of microsphere foaming agent into the injection molding particles to be foamed, and uniformly mixing to obtain the injection molding sole material.

### Example 6 Injection Molding Sole Material and Preparation Method Thereof

heating, oil-extending and plasticizing SBS 875 and SEBS 503 to the required hardness to obtain plasticized SBS 875 and plasticized SEBS 503, the heating temperature is 60° C.;

putting 30 parts of modified PLA obtained from Examples 1-4, 20 parts of plasticized SBS 875, 15 parts of plasticized SEBS 503, 15 parts of heavy calcium, 0.1 parts of heat stabilizer 1010, 0.2 parts of light stabilizer 531, 25 parts of epoxidized soybean oil, 2.5 parts of wear-resistant agent NM-406, 0.1 parts of anti-ultraviolet agent 326, and 2.5 parts of tackifying resin into a stirrer, uniformly mixing, adding 7 parts of epoxidized soybean oil, setting the stirring temperature to be 60° C., and continuously mixing until the epoxidized soybean oil is completely absorbed to obtain an injection molding material to be foamed;

extruding the injection molding material to be foamed into particles by using a screw extruder at 180° C., and cooling to obtain the injection molding particles to be foamed;

and adding 0.5 parts of microsphere foaming agent into the injection molding particles to be foamed, and uniformly mixing to obtain the injection molding sole material.

### Example 7 Injection Molding Sole Material and Preparation Method Thereof

heating, oil-extending and plasticizing SBS 875 and SEBS 503 to the required hardness to obtain plasticized SBS 875 and plasticized SEBS 503, the heating temperature is 60° C.;

putting 35 parts of modified PLA obtained from Examples 1-4, 15 parts of plasticized SBS 875, 15 parts of plasticized SEBS 503, 10 parts of heavy calcium, 0.1 parts of heat stabilizer 1010, 0.2 parts of light stabilizer 531, 25 parts of naphthenic oil, 2.5 parts of wear-resistant agent NM-406, 0.1 parts of anti-ultraviolet agent 326 and 2.5 parts of tackifying resin into a stirrer, uniformly mixing, adding 10 parts of epoxidized soybean oil, setting the stirring temperature to be 60° C., and continuously mixing until the epoxidized soybean oil is completely absorbed to obtain an injection molding material to be foamed;

extruding the injection molding material to be foamed into particles by using a screw extruder at 180° C., and cooling to obtain the injection molding particles to be foamed;

and adding 0.5 parts of microsphere foaming agent into the injection molding particles to be foamed, and uniformly mixing to obtain the injection molding sole material.

### Example 8 Injection Molding Sole Material and Preparation Method Thereof

heating, oil-extending and plasticizing SBS 875 and SEBS 503 to the required hardness to obtain plasticized SBS 875 and plasticized SEBS 503;

putting 40 parts of modified PLA obtained from Examples 1-4, 15 parts of plasticized SBS 875, 15 parts of plasticized SEBS 503, 10 parts of heavy calcium, 0.1 parts of heat stabilizer 1010, 0.2 parts of light stabilizer 531, 25 parts of naphthenic oil, 3 parts of wear-resistant agent NM-406, 0.1 parts of anti-ultraviolet agent 326, and 3 parts of tackifying resin into a stirrer, uniformly mixing, adding 15 parts of epoxidized soybean oil, setting the stirring temperature to be 60° C., and continuously mixing until the epoxidized soybean oil is completely absorbed to obtain an injection molding material to be foamed;

extruding the injection molding material to be foamed into particles by using a screw extruder at 180° C., and cooling to obtain the injection molding particles to be foamed;

and adding 0.5 parts of microsphere foaming agent into the injection molding particles to be foamed, and uniformly mixing to obtain the injection molding sole material.

### Example 9 Injection Molding Sole Material and Preparation Method Thereof

heating, oil-extending and plasticizing SBS 875 and SEBS 503 to the required hardness to obtain plasticized SBS 875 and plasticized SEBS 503, the heating temperature is 60° C.;

putting 30 parts of PLA without any treatment, 20 parts of plasticized SBS 875, 20 parts of plasticized SEBS 503, 15 parts of heavy calcium, 0.1 parts of heat stabilizer 1010, 0.2 parts of light stabilizer 531, 30 parts of naphthenic oil, 2.5 parts of wear-resistant agent NM-406, 0.1 parts of anti-ultraviolet agent 326, and 4 parts of tackifying resin into a stirrer, uniformly mixing, adding 10 parts of epoxidized soybean oil, setting the stirring temperature to be 60° C., and continuously mixing until the epoxidized soybean oil is completely absorbed to obtain an injection molding material to be foamed;

extruding the injection molding material to be foamed into particles by using a screw extruder at 180° C., and cooling to obtain the injection molding particles to be foamed;

and adding 0.5 parts of microsphere foaming agent into the injection molding particles to be foamed, and uniformly mixing to obtain the injection molding sole material as shown in Table 2.

TABLE 2
Summary of the main materials for Examples 5-9

| | Experimental examples | | | | | |
|---|---|---|---|---|---|---|
| Item | 5 | 6 | 7 | 8 | 9 | Comments |
| PLA | 25 | 30 | 35 | 40 | 30 | SBS 875 is oil-extended, plasticized |
| SBS 875 | 20 | 20 | 15 | 15 | 20 | and has a hardness of 54 A. |
| SEBS 503 | 20 | 15 | 15 | 15 | 20 | SEBS 503 is oil-extended, plasticized |
| Epoxidized soybean | 5 | 7 | 10 | 15 | 10 | and has a hardness of 28 A. |
| oil | | | | | | |
| Tackifying resin | 2 | 2.5 | 2.5 | 3 | 4 | |
| Wear-resistant agent | 2 | 2.5 | 2.5 | 3 | 2.5 | |
| NM-406 | | | | | | |
| Heavy calcium | 20 | 15 | 10 | 10 | 15 | |
| Microsphere foaming | 0.5 | 0.5 | 0.5 | 0.5 | 0.5 | |
| agent | | | | | | |

The injection molding sole material testing methods of Examples 5-9 were tested according to the relevant specifications for hardness, stretch, elongation, folding resistance, wear-resistance DIN, peel force in HG/T 3084-2010 injection molding shoe standards, and the test results are shown in Table 3.

TABLE 3
Test results for injection molding sole materials of Examples 5-9

| | Example 5 | Example 6 | Example 7 | Example 8 | Example 9 | |
|---|---|---|---|---|---|---|
| | Injection | Injection | Injection | Injection | Injection | |
| | molding | molding | molding | molding | molding | |
| | sole | sole | sole | sole | sole | Standard of |
| Item | material | material | material | material | material | reference |
| Hardness (A) | 40 | 43 | 46 | 50 | 50 | GB/T |
| | | | | | | 531.1-2008 |
| Tensile strength | 1.9 | 2.2 | 2.4 | 3.0 | 3.2 | GB/T |
| (mpa) | | | | | | 528-2009 |
| Elongation (%) | 400 | 400 | 350 | 300 | 240 | GB/T |
| | | | | | | 528-2009 |
| Folding | ≥60,000 | ≥60,000 | ≥60,000 | ≥60,000 | 40,000 | HG/T |
| resistance ≥40,000 | | | | | | 3054-2010 |
| times | | | | | | |
| Wear-resistant | 290 | 270 | 240 | 210 | 260 | GB/T |
| DIN ≤250 | | | | | | 9867-2008 |
| Peel force | 2.2 | 2.4 | 2.6 | 2.6 | 2.4 | GB/T |
| (kg/mm) | | | | | | 528-2009 |

As can be seen from the test results of Table 1, each index of the injection molding sole materials of Examples 5-8 met the HG/T-3084-2010 standard. The modified PLA is used for preparing the injection molding sole material, and the obtained injection molding sole material can meet the requirements of various indexes.

The injection molding sole material provided by the invention not only can be used for preparing soles of various shoes, but also can be applied to similar industrial products, such as protective sleeves, protective pads and the like with certain toughness, strength, compression resistance, folding resistance and resilience.

It should be noted that although the above-mentioned embodiments have been described herein, the scope of the invention is not limited thereby. Therefore, it is within the scope of the present invention to apply the above technical solutions directly or indirectly to other related technical fields based on the innovative concepts of the present invention, changes and modifications to the embodiments described herein, or equivalent structural or equivalent flow changes using the contents of the description and drawings of the present invention.

1. An injection molding sole material, comprising following components in parts by weight:
25-40 parts of modified PLA;
5-15 parts of epoxidized soybean oil;
10-20 parts of SBS 875;
15-20 parts of SEBS 503;
10-20 parts of heavy calcium;
20-30 parts of naphthenic oil;
0.1 parts of anti-ultraviolet agent 326;
0.1 parts of heat stabilizer 1010;
0.2 parts of light stabilizer 531;
2-4 parts of tackifying resin;
0.5 parts of microsphere foaming agent; and
2-4 parts of wear-resistant agent NM-406.

2. The injection molding sole material of claim 1, wherein the modified PLA is obtained by modifying PLA, PBAT, SBS-3546 and TMPTA under the action of a crosslinking accelerator.

3. The injection molding sole material of claim 2, wherein the crosslinking accelerator is zinc oxide.

4. The injection molding sole material of claim 3, wherein 15 parts of PBAT, 1-2 parts of TMPTA, 2 parts of zinc oxide and 10 parts of SBS-3546 are added per 100 parts of PLA in parts by weight.

5. A preparation method of an injection molding sole material, comprising following steps of:
heating, oil-extending and plasticizing SBS 875 and SEBS 503 to the required hardness to obtain plasticized SBS 875 and plasticized SEBS 503;
putting 25-40 parts of modified PLA, 10-20 parts of plasticized SBS 875, 15-20 parts of plasticized SEBS 503, 10-20 parts of heavy calcium, 0.1 parts of heat stabilizer 1010, 0.2 parts of light stabilizer 531, 2-4 parts of wear-resistant agent NM-406, 0.1 parts of anti-ultraviolet agent 326 and 2-4 parts of tackifying resin into a stirrer, uniformly mixing, adding 5-15 parts of epoxidized soybean oil, setting the stirring temperature to be 60° C., and continuously mixing until the epoxidized soybean oil is completely absorbed to obtain an injection molding material to be foamed;
extruding the injection molding material to be foamed into particles by using a screw extruder at 180° C., and cooling to obtain the injection molding particles to be foamed; and
adding 0.5 parts of microsphere foaming agent into the injection molding particles to be foamed, and uniformly mixing to obtain the injection molding sole material.

6. The preparation method of the injection molding sole material of claim 5, wherein the oil-extended and plasticized SBS 875 and the plasticized SEBS 503 have hardness of 54A and 28A, respectively.

7. The preparation method of the injection molding sole material of claim 5, wherein the modified PLA has a molecular weight between 10,000 and 15,000.

8. The preparation method of the injection molding sole material of claim 5, wherein the injection molding particles to be foamed are 2.5±0.2 mm in diameter and 2.5±0.2 mm in length.

9. A sole, comprising the injection molding sole material of claim 1.

10. A sole, comprising the injection molding sole material of claim 2.

11. A sole, comprising the injection molding sole material of claim 3.

12. A sole, comprising the injection molding sole material of claim 4.

13. A use of the injection molding sole material of claim 1.

14. A use of the injection molding sole material of claim 2.

15. A use of the injection molding sole material of claim 3.

16. A use of the injection molding sole material of claim 4.
